(19) United States
(12) Patent Application Publication
(10) Pub. No.: US 2011/0183796 A1
(43) Pub. Date: Jul. 28, 2011

(54) RATCHET-TYPE TENSIONER

(75) Inventors: Yuji Kurematsu, Osaka (JP); Manabu Hirayama, Osaka (JP)

(73) Assignee: Tsubakimoto Chain Co.,, Osaka (JP)

(21) Appl. No.: 13/011,321

(22) Filed: Jan. 21, 2011

(30) Foreign Application Priority Data
Jan. 28, 2010 (JP) 2010-017098

(51) Int. Cl. F16H 7/08

(52) U.S. Cl. 474/110

(57) ABSTRACT

In a ratchet-type tensioner having a toothed ratchet piston biased toward a rack of teeth formed on a protruding plunger in a direction transverse to the direction of plunger movement, the rack teeth and the ratchet teeth are mutually engageable and inclined at angles such that the biasing force urging the teeth of the ratchet piston into engagement with the rack teeth is sufficient to block retraction of the plunger during engine start-up but can be overcome when chain tension becomes excessive during engine operation following engine start-up.

### CROSS REFERENCE TO RELATED APPLICATIONS

This application claims priority on the basis of Japanese patent application 2010-017098, filed on Jan. 28, 2010. The disclosure of Japanese Patent application 2010-017098 is herein incorporated by reference.

### FIELD OF THE INVENTION

The invention relates to a ratchet-type tensioner for maintaining tension in the timing chain of an internal combustion engine.

### BACKGROUND OF THE INVENTION

A conventional hydraulic timing chain tensioner comprises a reciprocating plunger slidable in, and protruding from, a plunger-accommodating hole in a tensioner housing. The plunger and its housing form a high pressure oil chamber that receives oil under pressure from an engine oil pump. The plunger is biased in its protruding direction by a coil spring within the high pressure oil chamber. The spring and the oil pressure cooperatively exert a tensioning force to the timing chain. In a ratchet-type hydraulic tensioner, a ratchet mechanism can be provided to limit retraction of the plunger.

FIG. 9 shows a conventional ratchet-type hydraulic tensioner 500, having a plunger 514 slidable in, and protruding from, a housing 512. The tensioner also includes a subchamber 520, and a piston 526 that moves in subchamber 520 in a direction orthogonal to the direction in which plunger 514 moves. An oil passage 544 carries oil under pressure to the subchamber 520. An air chamber 528 on the side of piston 526 opposite from subchamber 520 communicates with the atmosphere through passage 532, and can be closed by one end of piston rod 524 when the piston 526 is moved against the biasing force of spring 534 by oil pressure acting within subchamber 520. The opposite end of the piston rod 524 is provided with teeth 536, which cooperate with the teeth of a rack formed on the plunger 514 to block retracting movement of plunger 514. The surfaces of teeth 536, and the surfaces of the teeth of rack 538 that engage teeth 536, are orthogonal to direction of movement of plunger 514. The tensioner of FIG. 9 is disclosed in Japanese Utility Model No. 2559664.

A problem with the prior art tensioner described above is that, the mutually engaging planes of teeth 536 and the teeth of rack 538 that block retracting movement of the plunger are orthogonal to the direction of movement of the plunger, they also restrict retracting movement of the plunger 514 that occurs due to excessive tension of the chain resulting from causes such as changes in engine temperature. For the same reason, the tooth plane structure wherein the mutually engaging tooth planes are orthogonal to the direction of plunger movement can also cause seizing of the plunger, excessive strain in the chain, and an increase in the noise generated by the chain as it travels.

The pitch of the ratchet teeth can be designed so that the backlash in the tensioner corresponds to an expected maximum retracting movement of the plunger caused by the excessive chain tension. However as the backlash increases, it becomes increasingly more difficult to control rattling or flapping noises in the timing chain that occur on engine start-up.

Known approaches addressing the above-described problems require additional parts, such as an orifice mechanism or an oil reserve mechanism, that increase the size of the tensioner, or require the use of a plunger biasing spring capable of sustaining a high load.

### SUMMARY OF THE INVENTION

This invention addresses the above-described problems by providing a ratchet-type tensioner capable of blocking plunger backlash on engine start-up, avoiding flapping noise, and preventing seizing of the plunger, but without restricting retracting movement of the plunger caused by excessive tension in the timing after engine start-up.

The tensioner is incorporated into the timing drive of an internal combustion engine wherein an endless circulating transmission chain transmits rotation from engine crankshaft sprocket to one or more engine camshaft sprockets. The tensioner comprises a housing formed with a plunger-accommodating hole having a bottom and an opening at an end opposite from the bottom, and an oil supply passage for introducing oil into the housing under pressure. A plunger, slidable in the plunger-accommodating hole, protrudes through the opening from the plunger-accommodating hole in a protruding direction and is arranged to maintain tension in the chain. The plunger has a rack of teeth formed on its outer peripheral surface and extending along the direction in which the plunger protrudes. A plunger-biasing spring urges the plunger in its protruding direction and is disposed in a high-pressure oil chamber formed by the plunger-accommodating hole and a hollow portion of the plunger. A check valve assembly at the bottom of the plunger-accommodating hole is connected to the oil supply passage to allow flow of oil from the supply passage into the high-pressure oil chamber but block reverse flow of oil. A ratchet piston accommodating hole is provided in the tensioner housing, and a ratchet piston is slidable in the piston-accommodating hole in a direction transverse to the direction in which the plunger protrudes. The ratchet piston has teeth engageable with the rack of teeth on the plunger. A ratchet-biasing spring urges the ratchet teeth of the ratchet piston toward the rack of teeth on the plunger.

The tensioner is characterized by the fact that the biasing force of the ratchet-biasing spring is greater than the maximum force component exerted by the rack teeth on the ratchet piston in the direction of piston movement when said engine is started, but smaller than a force component exerted by the rack teeth on the ratchet piston in said the direction of piston movement as a result of a force on the plunger that the chain is capable of exerting when excessive tension in the chain occurs during engine operation after the engine is started.

This aspect of the invention makes it possible restrict backlash, and to reduce flapping noises generated by the timing chain. In addition, the invention avoids the need for a special plunger biasing spring capable of accommodating a high load, and avoids the need for an orifice mechanism or oil reserve mechanism. Consequently, it does not require a large number of parts, and its manufacturing cost is low. The invention also makes it possible to downsize a tensioner while still achieving all of the capabilities of a larger tensioner.

The invention also makes it possible for the ratchet piston to disengage the rack teeth on the plunger allowing the plunger to retract when the tension in the chain becomes excessive after starting the engine. Retraction can occur until the force exerted by the rack teeth on the ratchet in the direction of ratchet movement falls below the force exerted by the ratchet-biasing spring, at which time the ratchet teeth again block retraction of the plunger.

Seizing of the plunger is avoided by permitting retraction of the plunger. Furthermore, by adjusting the biasing force exerted by the ratchet-biasing spring, it is possible to adjust the tensioner so that disengagement of its ratchet mechanism occurs when the tension in the timing chain reaches a particular level. In this way, the timing of disengagement caused by excessive tension of the chain after starting the engine can be adjusted.

Preferably the rack teeth of the plunger are concave-convex teeth defined by inclined planes facing in the direction of plunger retraction and inclined planes facing in the direction of plunger protrusion, and the ratchet teeth are also concave-convex teeth defined by inclined planes facing in the direction of plunger retraction, and inclined planes facing in the direction of plunger protrusion. Accordingly, it is possible to permit smooth, unrestricted, retraction of the plunger while preventing wear chipping of rack teeth and the ratchet teeth, and to avoid excessive shock from being applied to the ratchet-biasing spring, thereby improving the durability of the tensioner.

When the rack teeth are defined by steeply inclined planes facing in the direction of plunger retraction and more gradually inclined planes facing in the direction of plunger protrusion, and the ratchet teeth are defined by gradually inclined planes facing in the direction of plunger retraction, and more steeply inclined planes facing in the direction of plunger protrusion, it becomes possible to prevent retraction of the plunger on starting an engine, and to allow retraction of the plunger when timing chain tension becomes excessive after engine start up, using a simple, inexpensive, and reliable mechanism.

### BRIEF DESCRIPTION OF DRAWINGS

FIG. 1 is a schematic elevational view of an engine timing drive incorporating a ratchet tensioner according to the invention;

FIG. 2 is cross-sectional view of the tensioner shown in FIG. 1, and includes an enlarge auxiliary view of the ratchet mechanism, which includes rack teeth on the plunger and ratchet piston teeth engaged with the rack teeth;

FIG. 3 is a still more enlarged view showing the rack teeth and ratchet piston teeth of FIG. 2;

FIG. 4 is a schematic elevational view of the ratchet mechanism, illustrating the engagement of the ratchet piston teeth with the rack teeth as the plunger protrudes during engine start-up;

FIG. 5 is a schematic elevational view illustrating the engagement of the ratchet piston teeth with the rack teeth as the plunger retracts during engine start-up;

FIG. 6 is a schematic elevational view illustrating the engagement of the ratchet piston teeth with the rack teeth as the plunger retracts due to excessive tension in a timing chain during engine operation;

FIG. 7 is a schematic elevational view illustrating the disengagement of the ratchet piston teeth from the rack teeth as the plunger retracts due to excessive tension in a timing chain during engine operation;

FIG. 8 is a schematic elevational view illustrating the reengagement of the ratchet piston teeth with the rack teeth at the end of retracting movement of the plunger during engine operation; and

FIG. 9 is a cross-sectional view of a prior art ratchet tensioner.

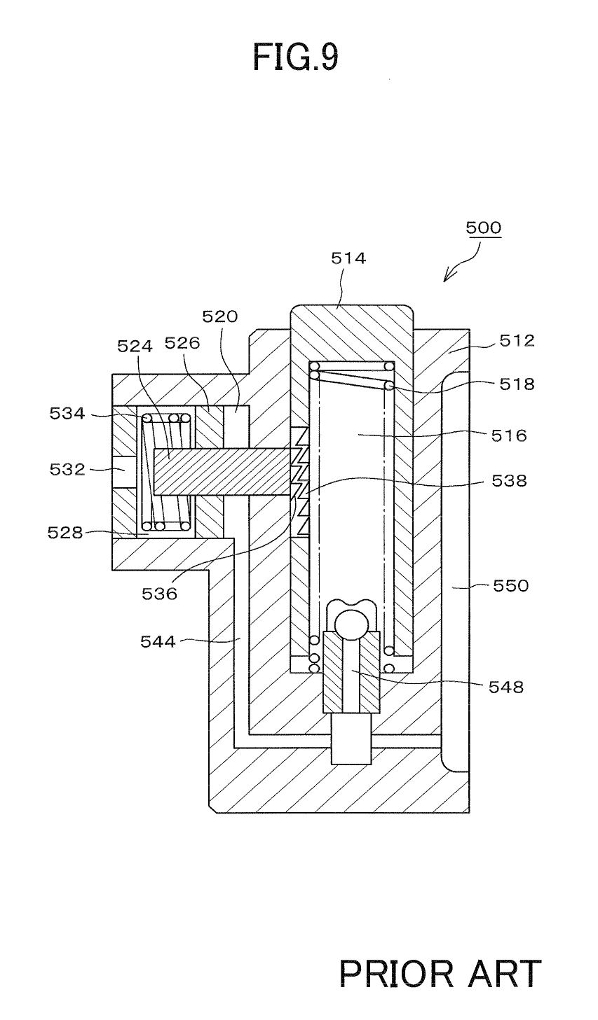

### DETAILED DESCRIPTION OF THE PREFERRED EMBODIMENT

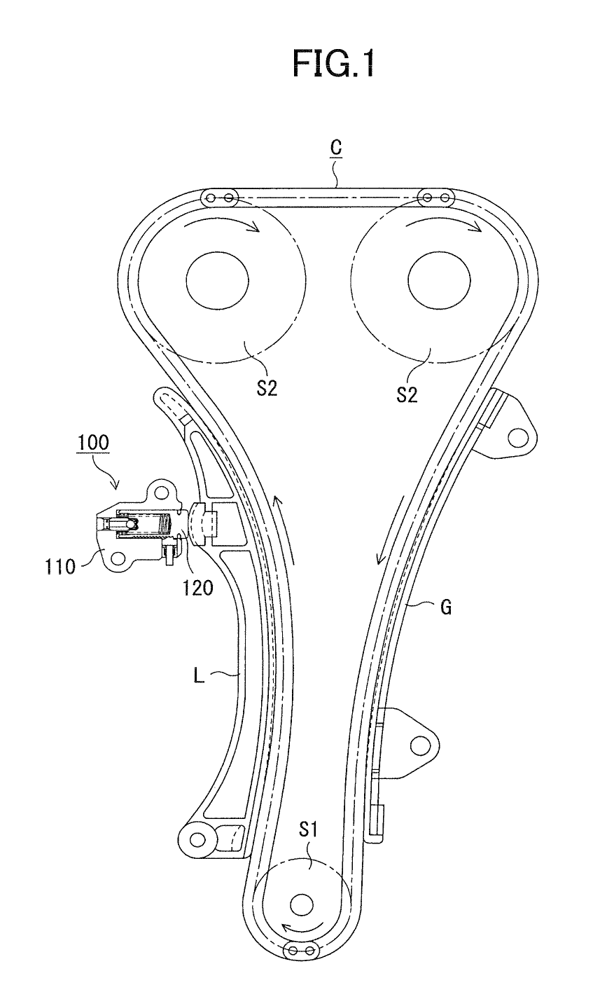

As shown in FIG. 1, a ratchet-type tensioner 100 is attached to an engine block (not shown) on the slack side of a timing chain C driving by a crankshaft sprocket S1 and driving camshaft sprockets S2. A plunger 120, protruding from the tensioner housing 110, is movable in and out of the tensioner housing toward the chain, and applies tension to the slack side of the chain through a lever L pivotably supported on the engine block by pressing the back of the lever at a location remote from the lever's pivot axis.

A stationary guide G for guiding the travel of the timing chain is fixed to the engine block on the tension side of the chain.

The chain transmits rotation from sprocket Si to sprockets S2, and the directions of the sprocket rotation and chain travel are indicated in FIG. 1 by arrows.

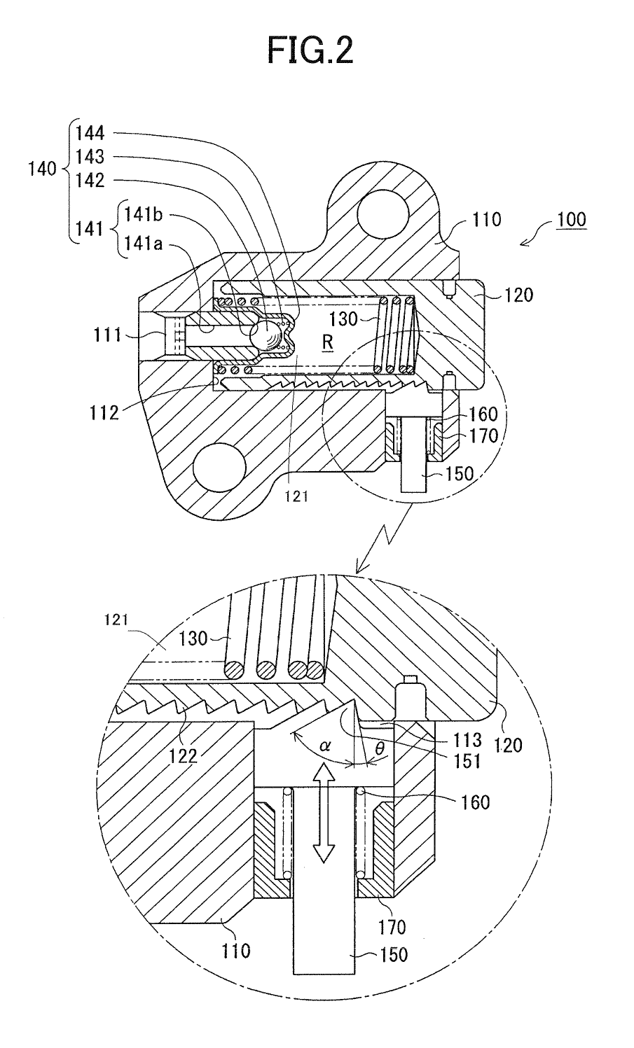

As shown in FIG. 2, tensioner 100 has a housing 110 having an oil supply passage 111 for introducing oil under pressure from an external supply, usually through a port in the engine block. A plunger 120 is slidable in, and protrudes from a plunger-accommodating hole 112 in the housing 110. A plunger-biasing spring 130 is disposed in a high-pressure oil chamber R formed by the plunger-accommodating hole 112 of the housing 110 and a hollow interior space 121 within the plunger 120. Spring 130 urges the plunger 120 in the protruding direction. A check valve assembly 140 at the bottom of the plunger-accommodating hole 112 allows oil to flow through passage 111 into high pressure oil chamber R, but block a reverse flow. The plunger 120 is provided with a rack composed of a set of rack teeth 122 formed in, and extending longitudinally along, its outer peripheral surface, which is otherwise cylindrical. A piston 150 is disposed in a cylindrical ratchet piston hole 113 which is formed in the housing 110 adjacent the opening of the plunger-accommodating hole 112 and the axis of which is perpendicular to the axis of the plunger-accommodating hole. The piston 150 is slidable in hole 113 in a direction orthogonal to the direction in which the plunger 120 moves. The piston 150 includes a set of ratchet teeth 151 engageable with rack teeth 122. A ratchet-biasing spring 160 urges piston 150 toward the piston 150 so that its ratchet teeth 151 can engage the rack teeth 122 on the plunger. A retaining plug 170 retains the ratchet piston 150 and the ratchet biasing spring 160 in ratchet piston hole 113.

The check valve assembly 140 can be any of a wide variety of known check valves capable of being disposed at the bottom of a plunger-accommodating hole in a tensioner. In the embodiment shown in FIG. 2, the check valve assembly 140 is composed of a seat 141 having an oil passage 141a connected to the oil supply passage 111 of the housing 110, a check ball 142 seated on a seating end of 141b of the seat 141, a ball-biasing spring 143 urging the check ball 142 toward the seat 141 and a bell-shaped retainer 144 for supporting the ball-biasing spring 143 and restricting movement of the check ball 142.

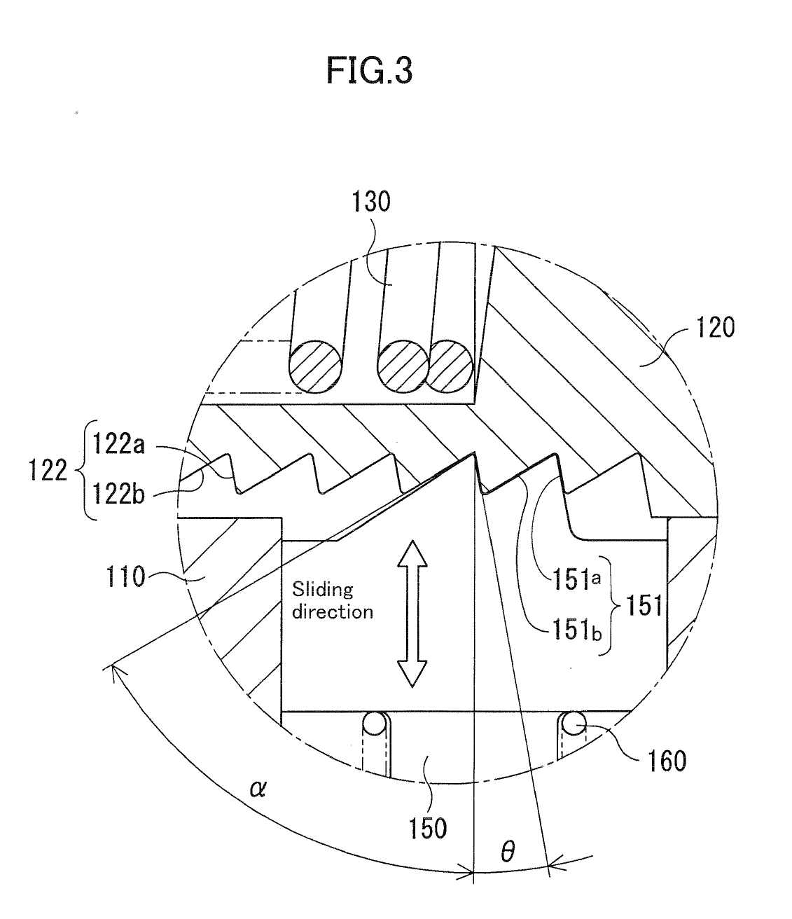

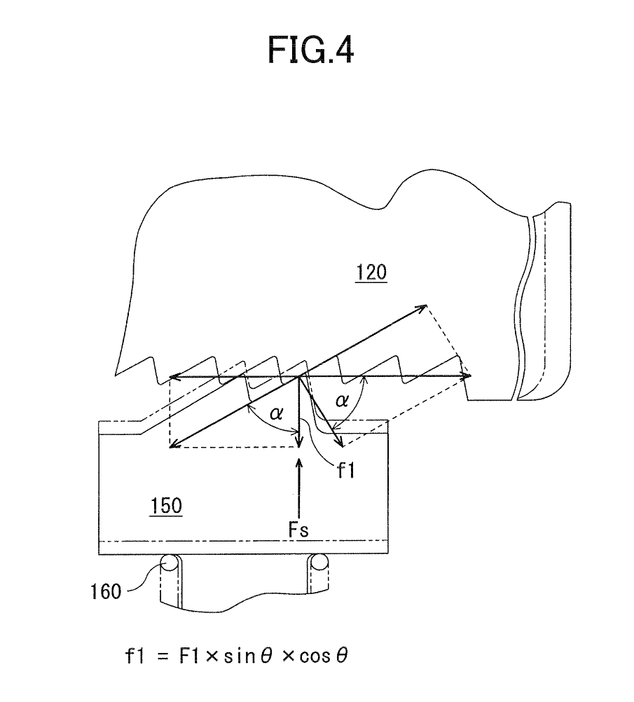

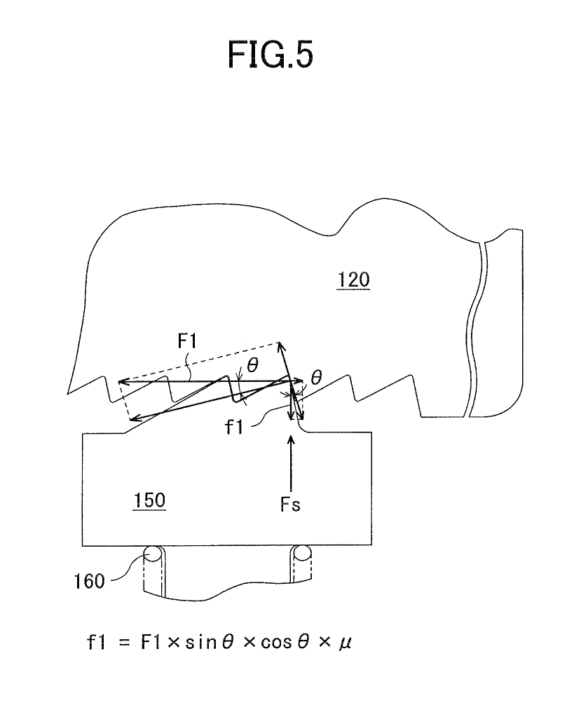

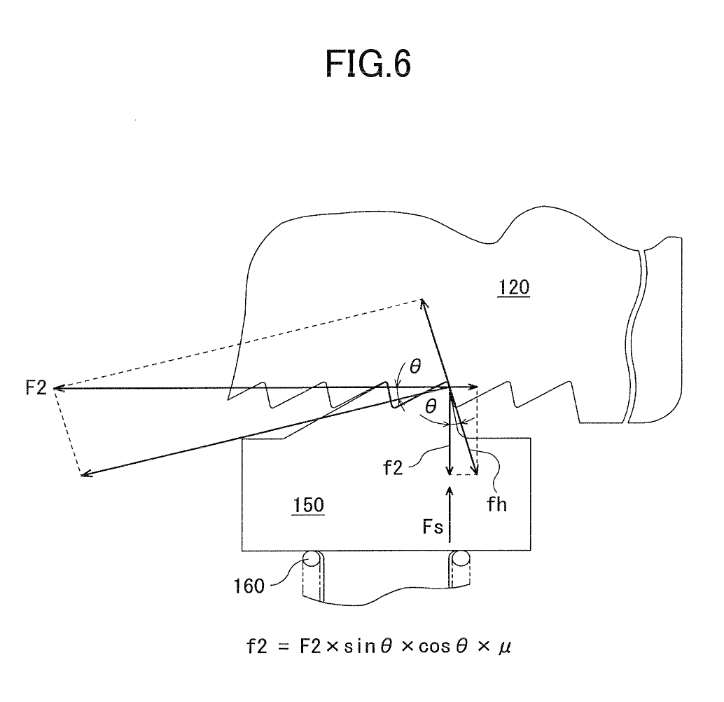

The relationships between the forces exerted on and by the plunger 120 and the piston is dependent on the inclinations of the mutually engageable surfaces of the rack teeth 122 and the ratchet teeth 151, and will be explained with reference to FIGS. 3-8. The biasing force Fs (FIG. 5) exerted by the ratchet biasing spring 160 is set so that it is greater than the magnitude of a force component f1, exerted in the direction of sliding movement of piston 150. Force component f1 is generated in reaction to force Fl exerted on the ratchet teeth of piston 150 by the plunger in the direction of plunger retraction on engine-start-up. Force F1 is the difference between the retracting force exerted on the plunger by the chain and the biasing force exerted on the plunger by the plunger-biasing spring 130 and oil pressure in the high pressure oil chamber (FIG. 2). As shown in FIG. 6, the biasing force Fs is also set so that it is smaller than the magnitude of force component f2, exerted in the direction of sliding movement of piston 150. Force component f2 is generated in reaction to the force F2 exerted on the ratchet teeth of piston 150 in the direction of plunger retraction when tension in the chain becomes excessive during engine operation after engine start-up. Force F2 is the difference between the retracting force exerted on the plunger by the timing chain and the biasing force exerted on the plunger by the plunger-biasing spring and oil pressure in the high pressure oil chamber.

As will be seen in FIG. 5, when the force Fl is generated on starting of the engine the biasing force Fs exerted by the ratchet-biasing spring 160 is greater than the magnitude of the opposing force component f1. Accordingly, the ratchet teeth 151 of piston 150 engage the rack teeth 122, blocking backward displacement of the plunger 120 and reducing backlash.

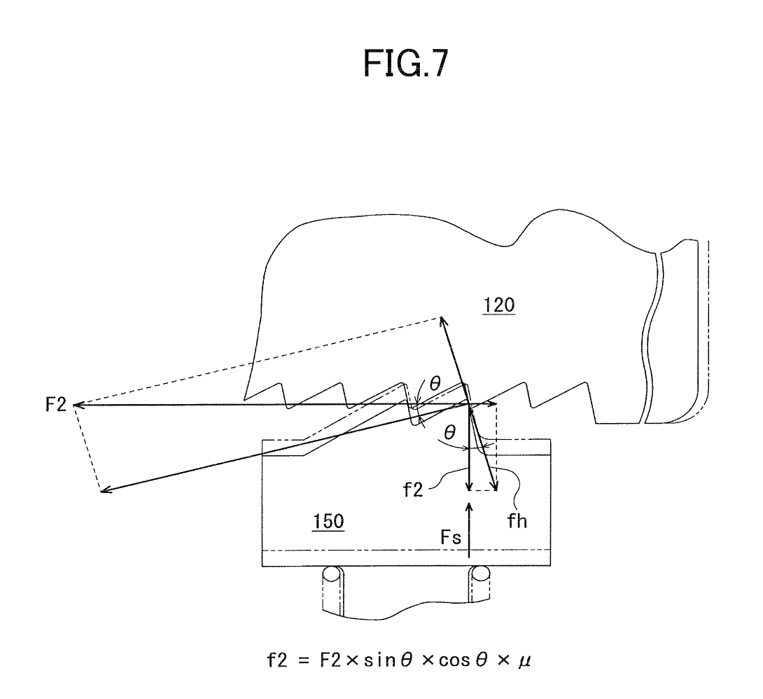

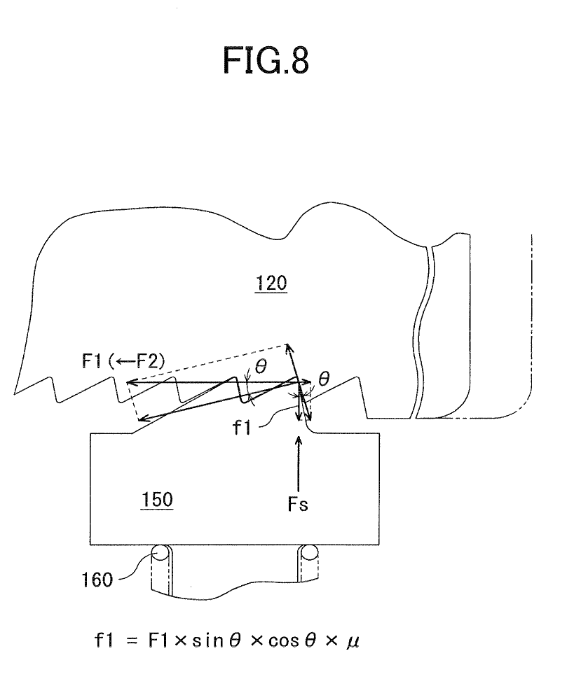

However, as shown in FIG. 6, when a larger force F2, generated when the tension of the chain becomes excessive after starting of the engine, is exerted, the force component f2 exerted by the rack teeth on the teeth of the ratchet piston 150 in the direction of sliding of the piston becomes greater than the force Fs exerted by the ratchet-biasing spring 160, and the teeth 151 of the ratchet piston 150 disengage the rack teeth 122 on the plunger 120 as shown in FIG. 7. The plunger 120 can then move backward by a distance corresponding to one or more teeth 122 of the rack until the magnitude of the force component f2 becomes less than the magnitude of the biasing force Fs exerted by the ratchet-biasing spring 160. Here, retracting movement of the plunger 120 due to the excessive tension of the chain during engine operation after start-up is not prevented, and backward displacement as shown in FIG. 8 is permitted.

The biasing force exerted by the plunger biasing spring 130 can be greater than the biasing force Fs exerted by the ratchet biasing spring 160. It is possible to adjust the timing of the disengagement caused by excessive tension in the chain after engine start-up by adjusting the magnitude of the biasing force Fs exerted by the ratchet biasing spring 160 within the range from fl to f2.

As shown in FIG. 3, the rack teeth 122 of the plunger 120 are concave-convex in form, being composed of rearward facing, steeply inclined, stop planes 122a, and forward facing, gradually inclined slide planes 122b. The ratchet teeth 151 on piston 150 are also concave-convex in form, being composed of forward facing, steep, inclined planes 151a and gradually inclined, rearward facing planes 151b.

When the tension in the chain becomes excessive after engine start-up as shown in FIG. 6, force F2, acting on planes 151a of the ratchet piston 150 can be resolved into two components, the reaction to the lesser one of which is a force fh, which acts along the direction of the planes 122a of the plunger rack teeth and planes 151a of the piston teeth. The force f2 that acts in the direction of movement of the piston 150 is a component of force fh, but as force f2 exceeds the piston-biasing force Fs, the ratchet teeth 151 can disengage the rack teeth 122 on the plunger 120. As shown in FIGS. 7 and 8, steep planes 122a of the rack teeth 122 slide over one or more of the opposing planes 151a of the ratchet piston teeth and gradual planes 151b of the ratchet piston come into engagement with gradual planes 122b of the rack. Thus the plunger can retract by a distance corresponding to one or more rack teeth.

As shown in FIG. 3, θ, the angle of inclination of the rearward facing planes 122a of the plunger rack teeth is smaller than a, the angle of inclination of the forward facing tooth planes 122b. This arrangement allows the plunger to move forward, but blocks disengagement of ratchet teeth 151 from the rack teeth 122 of the plunger when the force F1 is exerted by the plunger on the rack in the direction of plunger retraction on starting the engine.

Referring to FIG. 7, in order to permit retraction of the plunger when the timing chain is under excessive tension following engine start-up, the relationships of the magnitude of the component force f2 exerted in the direction of movement of the ratchet piston 150, the force F2 exerted in the direction of retraction of the plunger, and the biasing force Fs exerted by ratchet-biasing spring 160 may be expressed as follows:

f2=F2×cosθ×sinθ×μ

f2>Fs

where μ is the coefficient of contact friction between the rack teeth of the plunger and the ratchet teeth of the ratchet piston.

Referring to FIG. 5, in order to block retraction of the plunger to reduce backlash on starting of an engine the relationship of the magnitude of the component force fl exerted in the direction of movement of the ratchet piston 150 the force Fl exerted in the direction of retraction of the plunger, and the biasing force Fs exerted by the ratchet-biasing spring 160 may be expressed as follows:

F1×cosθ×sinθ×μ

f1<Fs

The disengagement of the ratchet teeth 151 on the piston 150 from the rack teeth 122 of the plunger 120 when the tension of the chain becomes excessive after starting the engine, is illustrated in FIGS. 6 through 8.

A broken line to the right of the protruding end of the plunger 120 in FIG. 8 denotes the position of the end of the plunger when excessive tension of the chain occurs after starting the engine, i.e., the condition shown in FIG. 6. A broken line above the ratchet piston 150 in FIG. 7 denotes the position of the ratchet piston when excessive tension of the chain occurs after starting the engine, i.e., the condition shown in FIG. 6.

Force F2, generated because the tension in the chain becomes excessive after starting the engine, acts on the tooth planes 151a of the ratchet piston 150. Its component, f2, is the force exerted on the piston 150 in the direction of movement of the piston, as shown in FIG. 6.

The action of the force component f2 causes the piston to retract, allowing the plunger to move in the retracting direction. When the teeth of the piston clear the teeth of the plunger rack, the ratchet tooth planes 151a disengage the tooth planes 122a of the rack. When this disengagement occurs, the plunger 120 continues to move in the retracting direction as planes 122b of the plunger rack begin to slide on opposing planes 151b of the ratchet piston until planes 112a of the plunger again come into abutment with opposing planes 151a of the ratchet piston side as shown in FIG. 8. When the force component f1 no longer exceeds force F2, the retraction of the plunger stops. The plunger 120 can retract in this manner by a distance corresponding to one or more rack teeth 122, thus taking advantage of excessive tension in the chain to recover from excessive projection of the plunger 120.

Because the biasing force Fs exerted by the ratchet-biasing spring 160 is set at a level greater than the force component f1, in the sliding direction of the ratchet piston 150, generated on starting the engine but smaller than the force f2 component, in the sliding direction of the ratchet piston 150, generated when the tension of the chain becomes excessive after starting the engine, the tensioner can reduce the flapping noise of the timing chain by blocking retracting movement of the plunger 120 on engine start-up and prevent seizing of the plunger, but permit the retraction of the plunger when excessive chain tension occurs after starting the engine.

The tensioner of the invention does not require a special plunger biasing spring 160 for accommodating a high load, nor does it require an orifice mechanism or oil reserve mechanism. Consequently, the number of parts required in the tensioner is not excessive, the manufacturing cost of the tensioner can be reduced, and the size of the tensioner can also be reduced.

Because the rack teeth 122 of the plunger 120 are formed so that the angle θ of the planes 151a is less than the angle a of planes 151b, the tensioner can permit smooth and unrestricted retraction of the plunger 120 while preventing the wear and chipping that are prone to occur both in the rack teeth and in the teeth of ratchet piston when the tension of the chain becomes excessive after starting the engine. The form of the teeth also prevents excessive shock from being applied to the ratchet-biasing spring 160. Thus, the ratchet-type tensioner 100 of the invention can exhibit superior durability among its other advantageous effects.

The construction of the ratchet-type tensioner of the invention may modified, as long as the biasing force of the ratchet-biasing spring is greater than the maximum force component exerted by the rack teeth on the ratchet piston in the direction of movement of the piston when the engine is started, but smaller than a force component exerted by the rack teeth on the ratchet piston in the direction of movement of the ratchet piston as a result of a force on the plunger that the chain is capable of exerting when excessive tension in the chain occurs during engine operation after the engine is started.

As an example of a modification, instead of providing for introduction of oil directly from an oil pump through an oil supply passage formed in the housing, oil can be supplied from an oil reservoir, formed on a back part of the housing, for temporary storage of oil supplied from the oil pump. Similarly, the check valve assembly can be selected from any of various kinds, as long as it blocks reverse flow of oil from the high-pressure oil chamber to the oil supply passage.

The biasing force exerted by the ratchet-biasing spring may have any absolute value as long as it is greater than the force component exerted on the ratchet piston by the rack teeth in the sliding direction of the ratchet piston on starting the engine and less than the corresponding force component generated when chain tension becomes excessive during engine operation. Preferably, in selecting the ratchet biasing spring, the coefficient of contact friction between the rack teeth of the plunger and the ratchet teeth of the ratchet piston is taken into account.

What is claimed is:

1. In the timing drive of an internal combustion engine wherein an endless circulating transmission chain transmits rotation from engine crankshaft sprocket to one or more engine camshaft sprockets, a ratchet-type tensioner for maintaining tension in said transmission chain, the tensioner, comprising:
a housing formed with a plunger-accommodating hole having a bottom, an opening at an end of the hole opposite from said bottom, and an oil supply passage for introducing oil into the housing under pressure;
a plunger slidable in the plunger-accommodating hole, said plunger protruding through said opening from the plunger-accommodating hole in a protruding direction and being arranged to maintain tension in said chain, said plunger having an outer peripheral surface and a rack of teeth formed on said outer peripheral surface, said rack of teeth extending along said protruding direction;
a plunger-biasing spring urging the plunger in said protruding direction and disposed in a high-pressure oil chamber formed by the plunger-accommodating hole and a hollow portion of the plunger;
a check valve assembly at the bottom of said plunger-accommodating hole, and connected to said oil supply passage, for allowing flow of oil from said passage into said high-pressure oil chamber but blocking reverse flow of oil from said high pressure oil chamber to said oil supply passage;
a ratchet piston accommodating hole in said housing;
a ratchet piston slidable in said piston-accommodating hole in a direction transverse to said protruding direction of the plunger, said ratchet piston having teeth engageable with said rack of teeth on the plunger; and
a ratchet-biasing spring urging said ratchet teeth of the ratchet piston toward the rack of teeth on the plunger;
wherein the biasing force of the ratchet-biasing spring is greater than the maximum force component exerted by the rack teeth on the ratchet piston in said transverse direction when said engine is started but smaller than a force component exerted by the rack teeth on the ratchet piston in said transverse direction as a result of a force on said plunger that the chain is capable of exerting when excessive tension in the chain occurs during engine operation after the engine is started.

2. The ratchet-type tensioner according to claim 1, wherein the rack teeth of said plunger are concave-convex teeth defined by inclined planes facing in the direction of plunger retraction and inclined planes facing in the direction of plunger protrusion, and wherein the ratchet teeth are concave-convex teeth defined by inclined planes facing in the direction of plunger retraction, and inclined planes facing in the direction of plunger protrusion.

3. The ratchet-type tensioner according to claim 1, wherein the rack teeth of said plunger are concave-convex teeth defined by steeply inclined planes facing in the direction of plunger retraction and more gradually inclined planes facing in the direction of plunger protrusion, and wherein the ratchet teeth are concave-convex teeth defined by gradually inclined planes facing in the direction of plunger retraction, and more steeply inclined planes facing in the direction of plunger protrusion.
